(19) United States
(12) Patent Application Publication
(10) Pub. No.: US 2006/0243846 A1
(43) Pub. Date: Nov. 2, 2006

(54) Vehicle sensitive seat belt retractor control with suppressed Z-axis sensitivity

(75) Inventor: Gunter K. Clute, Bloomfield Hills, MI (US)

Correspondence Address: AUTOLIV ASP, 3350 AIRORT ROAD, OGDEN, UT, 84405, US

(73) Assignee: Autoliv ASP, Inc.

(21) Appl. No.: 11/118,270

(22) Filed: Apr. 29, 2005

(51) Int. Cl. B60R 22/40

(52) U.S. Cl. 242/384.6

(57) ABSTRACT

A vehicle sensitive retractor control system having reduced sensitivity to Z-axis acceleration. The retractor control system incorporates a rolling ball mass which, in its resting position, acts on a locking lever to prevent it from engaging a ratchet wheel of the seat belt retractor spool. The locking lever has its center of gravity positioned to urge it to move into a locking engagement position with the ratchet wheel. In response to accelerations in the horizontal plane, the rolling ball mass becomes unseated from its resting position and no longer contacts and influences the locking lever, enabling it to lock the retractor. In response to Z-axis acceleration, the ball mass becomes unseated out of contact with the locking lever. An auxiliary mass may be provided which acts on the locking lever in the event of a rollover to force the locking lever into the locking position.

### FIELD OF THE INVENTION

This invention relates to an automotive occupant restraint seat belt retractor, and particularly to a vehicle sensitive control system for such a retractor.

### BACKGROUND OF THE INVENTION

Motor vehicles are frequently equipped with active occupant restraint systems such as seat belt assemblies. Seat belt assemblies typically have a lap and shoulder belt portion for restraining the occupant in the event of an impact or rollover event. To enhance the comfort and convenience provided by the seat belt system, retractors are provided which allow the belt webbing to be freely paid-out and retracted when the vehicle is not subjected to unusual acceleration forces or inclination. In the event of exposure to such forces, a retractor control system activates to lock the retractor to prevent additional pay-out of webbing. Thus, the retractor locks in a manner to enable the seat belt webbing to restrain the occupant. Such retractor control systems take various forms. One category of such control systems are known as vehicle sensitive control systems. These systems are sensitive to acceleration forces acting on the vehicle, for example in the case of a frontal impact condition in which the vehicle experiences a high level deceleration load. Such devices also lock the retractor in the event of side impacts, rollovers, and when certain other forces act on the vehicle.

Another category of such retractor control systems are known as webbing sensitive control systems. These devices operate much in the manner of a centrifugal clutch and sense the rotational speed of the retractor spool, such that when extremely high angular accelerations of the retractor spool occurs associated with rapid pay-out of webbing, the control system engages to lock the retractor. This invention is related to an improved vehicle sensitive retractor control system.

As mentioned previously, vehicle sensitive retractor control systems must be sensitive to acceleration loads acting in various axes and planes. Primarily important are impacts to the vehicle creating acceleration loads acting in the horizontal plane, such as front, rear, or side impact conditions. However, if a rollover event has occurred, it is important that the retractor lock to restrain the occupant. Typical vehicle sensitive retractor control systems utilize a pendulum or rolling ball mass to activate a locking lever which engages with a ratchet wheel of the retractor webbing spool. When acceleration loads act on the vehicle, the rolling ball mass or pendulum moves to urge a locking lever to engage with the ratchet wheel of the retractor spool, thus locking the spool from further pay-out of webbing. These devices have been utilized for many decades and have proven to be reliable and effective retractor control systems.

Designers of vehicle sensitive control systems attempt to design the systems such that they lock the retractor when necessary to restrain the occupant while minimizing locking during normal driving conditions. Normal maneuvers of the vehicle, driving up and down inclines and over bumpy roads can produce forces causing a periodic locking of the retractor. This periodic locking in normal driving conditions is undesirable from an occupant comfort viewpoint. The problems of unnecessary locking of retractors tend to be especially significant in heavy duty truck-type vehicles. These vehicles, due to their operating conditions, heavy loads, and suspension systems, tend to undergo significant jaunts or vertical displacements as they are driven, especially over uneven road surfaces. This motion creates accelerations in the Z-axis direction, defined as the vertical axis of the vehicle. Presently available vehicle sensitive retractor control systems generally produce undesirable locking due to normally encountered Z-axis accelerations, especially in heavy truck applications.

### SUMMARY OF THE INVENTION

This invention provides a vehicle sensitive retractor control system having intentionally reduced sensitivity to Z-axis accelerations. The control system utilizes a rolling mass which, when displaced, allows a locking lever to lock the retractor. However, when the rolling mass is unseated from its normal resting position, it renders the control level relatively insensitive to Z-axis accelerations. In order to provide the desired Z-axis sensitivity for rollover events, an auxiliary mass or device can be used to engage the locking lever in such conditions, forcing it into locking engagement with the retractor ratchet wheel.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a diagrammatic cross-sectional view through a seat belt retractor including the vehicle sensitive retractor control system of this invention;

FIG. 2 is a view of the vehicle sensitive retractor control system shown in FIG. 1 shown while the system is exposed to an acceleration load acting in the horizontal plane;

FIG. 3 is an alternate embodiment of the vehicle sensitive retractor control system of FIG. 1 illustrating a rotating mass for providing rollover sensitivity;

FIG. 4 is a partial pictorial view of a third embodiment of a vehicle sensitive retractor control system in accordance with this invention utilizing a secondary locking ball for rollover sensitivity.

### DETAILED DESCRIPTION OF THE INVENTION

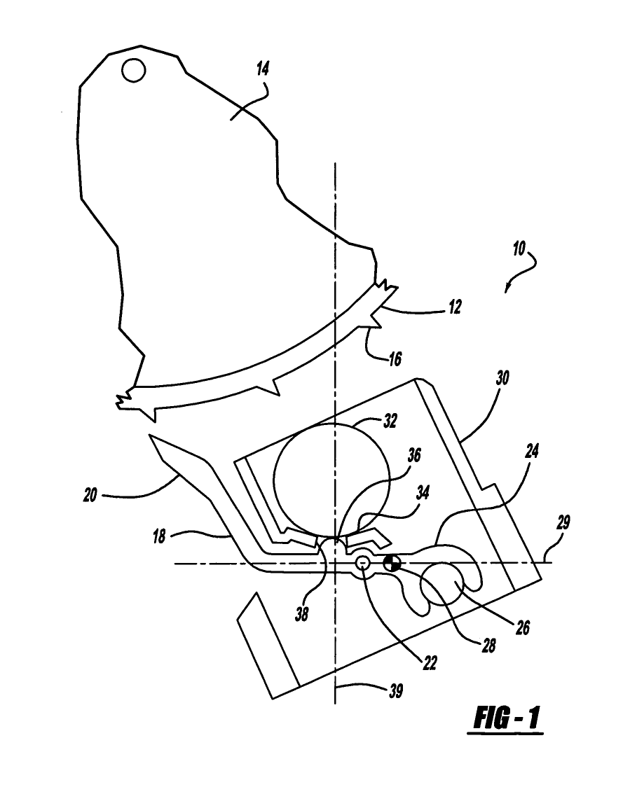

A vehicle sensitive retractor control system in accordance with a first embodiment of this invention is shown in FIG. 1 and is identified by reference number 10. Control system 10 is used with ratchet wheel 12 which is part of a belt retractor having rotating webbing spool 14. Webbing spool 14 rotates as seat belt webbing (not shown) is extended from the retractor and retracted into the retractor during its normal operation. An internal torsion spring (not shown) acts on webbing spool 14, urging it rotationally to pull the webbing into the retractor. Ratchet wheel 12 includes an array of angled teeth 16 around its perimeter. These teeth 16 are used to enable control system 10 to lock retractor spool 14 in certain operating conditions.

Control system locking lever 18 includes an upward projecting engagement finger 20 and is rotatable over a limited range of angular motion about pivot 22. The rotational motion of locking lever 18 is about an axis aligned perpendicular (normal) to the drawing sheet of FIG. 1. When affixed to a vehicle, the retractor having control system 10 would be positioned as shown in FIG. 1 when viewed from the side of the vehicle, with the right-hand end of the assembly facing the front of the vehicle. Arm 24 extends in the opposite direction from pivot 22 from engagement finger 20 and mounts mass 26. In other configurations of the present invention, mass 26 could be integrated with the material forming locking lever 18 or arm 24. The overall mass distribution of locking lever 18 including mass 26 places its center of gravity (CG) 28 at the position illustrated in FIG. 1 which is on the opposite side of the pivot 22 from engagement finger 20, while generally positioned in the same horizontal plane 29 as pivot 22. Thus, if no other forces are acting on locking lever 18, the position of CG 28 would urge it to rotate in the clockwise direction with regard to the orientation of the element shown in FIG. 1, urging engagement finger 20 to engage with ratchet wheel teeth 16.

Ball socket 30 is fixed to the frame of the retractor (not shown) and provides an enclosed area for the retention of ball mass 32. As shown in FIG. 1, ball socket 30 includes a nest surface 34 which positions ball mass 32 in the position shown in FIG. 1. In that position, ball mass 32, resting on nest surface 34, engages with locking lever projection 36 which projects through aperture 38 of the nest surface. FIG. 1 illustrates the orientation of the elements in a normal resting condition or when no significant acceleration loads are acting on control system 10 except gravitational forces. In this position, ball mass 32 rests on nest surface 32 and its engagement with projection 36 maintains engagement finger 20 in a position out of engagement with ratchet wheel 12.

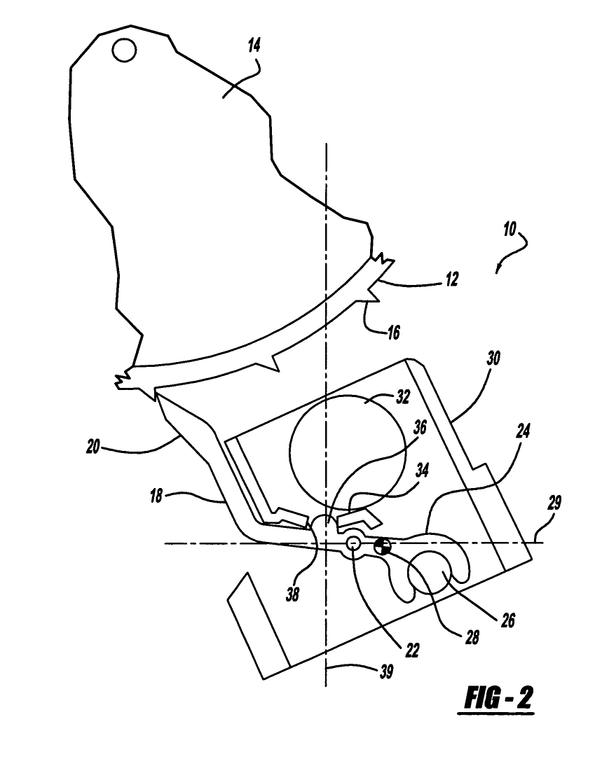

In the event that control system 10 is exposed to an acceleration load acting in a horizontal plane designated by line 29, ball mass 32 becomes unseated from nest surface 34. In this position, ball mass 32 does not contact projection 36, and thus does not restrict motion of locking lever 18. This is shown in FIG. 2 which shows movement of ball mass 32 in the event of a frontal impact of the vehicle. In this condition, the positioning of CG 28 to the right of pivot 22 causes clockwise rotation of locking lever 18. This positions engagement finger 20 to engage with ratchet wheel teeth 16 which would be rotating as webbing is paid-out from the retractor.

As mentioned previously, retractor control system 10 is intentionally designated to be relatively insensitive to accelerations in the vertical Z-axis (shown by line 39 in FIG. 1). A downward acting Z-axis acceleration would cause ball mass 32 to become unseated (lifted) from nest surface 34, but because of the positioning of CG 28, locking lever 18 would be urged to rotate in the counterclockwise direction (out of engagement with ratchet wheel 12). An upward acting Z-axis acceleration would cause ball mass 32 to be more firmly engaged within nest surface 34 and, due to contact with projection 36, engagement between locking lever 18 and ratchet wheel 12 would be prevented. Unlike prior art vehicle sensitive retractor control systems having a rolling or pivoting moveable mass which utilize the mass to cause engagement, ball mass 32, once unseated, does not act on the locking lever 18. Rather, ball mass 32 engages locking lever 18 only in the normal (non-locking) condition.

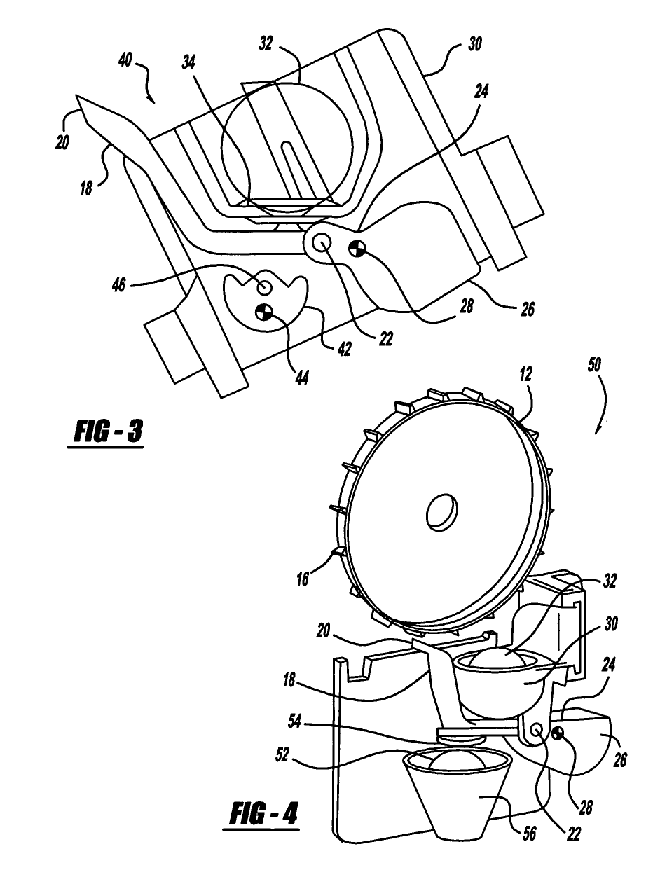

FIG. 3 illustrates a second embodiment of a control system 10 in accordance with this invention which is generally designated by reference number 40. Elements of control system 40, along with the embodiment shown in FIG. 4, which are identical with those described previously, are identified by like reference numbers. Control system 40 differs from control system 10 with the addition of an auxiliary rotating mass 42 which is rotatable about pivot 46. In the event that the vehicle is engaged in a rollover event and become inverted, rotating mass 42 will flip over since its center of gravity (CG) 44 would tend to fall below its pivot 46 under the influence of gravity. When the vehicle is inverted, the rotating mass 42 flips over and the mass would rotate causing it to engage with locking lever 18, thus forcing engagement finger 20 into engagement with ratchet wheel 12. Locking lever 18 shown in FIG. 3 differs slightly from the design shown in FIGS. 1 and 2 since arm 24 and mass 26 are integrated.

FIG. 4 illustrates control system 50 in accordance with a third embodiment of this invention. In this design, an auxiliary locking ball 52 is utilized which is positioned below locking lever 18. In the event of a rollover causing the associated vehicle to be inverted, auxiliary locking ball 52 falls against and rests on locking lever 18 under the influence of gravity to force it into engagement with ratchet wheel 12. A significant gap is present between the top of auxiliary locking ball 52 and locking lever engagement pad 54 so that accelerations associated with vehicle braking, do not cause auxiliary locking ball 52 to engage with locking lever 18. However, in the event of a rollover event as mentioned previously, auxiliary locking ball 52 can fall from its nested position within ball cup 56 to engage with locking lever 18.

While the above description constitutes the preferred embodiment of the present invention, it will be appreciated that the invention is susceptible to modification, variation and change without departing from the proper scope and fair meaning of the accompanying claims.

1. A vehicle sensitive seat belt retractor control system for locking a vehicle seat belt retractor in the event acceleration loads acting on the retractor in a horizontal plane while having a reduced sensitivity to acceleration loads acting a Z-axis direction, perpendicular to the horizontal plane, the control system engaging with a toothed ratchet wheel rotatable with a spool of the retractor, the control system comprising:
a locking lever pivotable about a pivot, the locking lever having an engagement finger for causing engagement with the ratchet wheel to arrest rotation of the spool, the locking lever having a center of gravity positioned relative to the pivot such that in a non-inverted orientation of the vehicle, gravity acts on the locking lever to urge the locking lever to pivot from a disengaged position to a locking position causing engagement with the ratchet wheel, and
a moveable mass displaceable from a resting position to a displaced position in response to acceleration loads acting in the horizontal plane and in the Z-axis direction, the moveable mass contacting the locking lever while in the resting position to place the locking lever in the disengaged position, wherein when acceleration loads act on the moveable mass, the movable mass moves to the displaced position wherein the locking lever is enabled to move to the engaged position in response to acceleration loads acting in the horizontal plane.

2. A vehicle sensitive retractor control system according to claim 1 further comprising the moveable mass in the form of a ball.

3. A vehicle sensitive retractor control system according to claim 2 further comprising a ball socket having a nest surface for positioning the ball in the resting position, the nest surface having an aperture for receiving a projection of the locking lever.

4. A vehicle sensitive retractor control system according to claim 1 further comprising the engagement finger contacting and engaging the ratchet wheel.

5. A vehicle sensitive retractor control system according to claim 1 further comprising an auxiliary moveable mass positioned to contact the locking lever and urge the locking lever to the engaged position when the vehicle is in an inverted condition.

6. A vehicle sensitive retractor control system according to claim 5 wherein the auxiliary moveable mass comprises a rotating pendulum.

7. A vehicle sensitive retractor control system according to claim 5 wherein the auxiliary moveable mass comprises a secondary ball.

8. A vehicle sensitive retractor control system according to claim 1 wherein the position of the center of gravity of the locking lever is generally horizontally displaced from the pivot axis.

9. A vehicle sensitive retractor control system according to claim 8 wherein the locking lever center of gravity is positioned on a side of the locking lever opposite the engagement finger.

10. A vehicle sensitive retractor control system according to claim 1 wherein the moveable mass in the displaced position does not contact the locking lever.

11. A vehicle sensitive seat belt retractor control system for locking a vehicle seat belt retractor in the event acceleration loads acting on the retractor in a horizontal plane while having a reduced sensitivity to acceleration loads acting on a Z-axis direction, perpendicular to the horizontal plane, the control system engaging with a toothed ratchet wheel rotatable with a spool of the retractor, the control system comprising:
a locking lever pivotable about a pivot, the locking lever having an engagement finger for engagement with the ratchet wheel to arrest rotation of the spool, the locking lever having a center of gravity positioned relative to the pivot such that in a non-inverted orientation of the vehicle, gravity acts on the locking lever to urge the locking lever to pivot from a disengaged position to a locking position engagement with the ratchet wheel, and
a moveable ball mass carried by a ball socket displaceable from a resting position in a nest surface of the ball socket to a displaced position moved from the resting position in response to acceleration loads acting in the horizontal plane and in the Z-axis direction, the moveable mass contacting the locking lever while in the resting position to place the locking lever in the disengaged position, wherein when acceleration loads act on the moveable mass, the movable mass moves to the displaced position out of contact with the locking lever wherein the locking lever is enabled to move to the engaged position in response to acceleration loads acting in the horizontal plane but is not urged to move to the locking position in response to acceleration loads acting in the Z-axis direction.

12. A vehicle sensitive retractor control system according to claim 11 further comprising an auxiliary moveable mass positioned to contact the locking lever and urge the locking lever to the engaged position when the vehicle is in an inverted condition.

13. A vehicle sensitive retractor control system according to claim 12 wherein the auxiliary moveable mass comprises a rotating pendulum.

14. A vehicle sensitive retractor control system according to claim 12 wherein the auxiliary moveable mass comprises a secondary ball.

15. A vehicle sensitive retractor control system according to claim 12 wherein the nest surface having an aperture for receiving a projection of the locking lever.

16. A vehicle sensitive retractor control system according to claim 12 wherein the locking lever center of gravity is positioned on a side of the locking lever opposite the engagement finger.

17. A vehicle sensitive retractor control system according to claim 12 wherein the moveable mass in the displaced position does not contact the locking lever.
